(19) United States
(12) Patent Application Publication
(10) Pub. No.: US 2007/0229264 A1
(43) Pub. Date: Oct. 4, 2007

(54) Software method and system for encapsulation of RFID data into a standardized globally routable format

(76) Inventor: Ronald Eveland, Milwaukee, WI (US)

Correspondence Address: BOYLE FREDRICKSON S.C., 840 North Plankinton Avenue, MILWAUKEE, WI, 53203, US

(21) Appl. No.: 11/599,502

(22) Filed: Nov. 14, 2006

Related U.S. Application Data
(60) Provisional application No. 60/736,517, filed on Nov. 14, 2005.

(51) Int. Cl. G08B 13/14; G06F 15/16

(52) U.S. Cl. 340/572.1; 709/230

(57) ABSTRACT

A system and method for locating items using radio frequency identification tags is provided in which the tags are configured with information concerning the items to which they are attached that is formatted in a standardized Internet compatible protocol. By placing the information on the tags in an Internet compatible protocol, information from the tags can be obtained by a variety of mobile routing devices and transferred directly or indirectly to other devices utilizing the Internet. This ability to transfer information in a standardized Internet compatible protocol allows for greatly enhanced access to information contained on a tag that allows for increased abilities to locate and trace items including RFID tags configured in this manner.

### CROSS REFERENCE TO RELATED APPLICATION

This application claims priority under 35 U.S.C. §119 from U.S. Provisional Patent Application Ser. No. 60/736,517 filed on Nov. 14, 2005, the entirety of which is incorporated by reference herein.

### FIELD OF THE INVENTION

The present invention relates to passive radio frequency identification data (RFID) tags and labels in general and more particularly to a method and system for locating and retrieving information contained on tags of this type.

### BACKGROUND OF THE INVENTION

RFID tags have long been utilized to provide information concerning items to which the tags are attached. The RFID tags include an electronic data storage component on which information regarding the tag and the item to which the tag is attached is stored. The information can be stored in the storage component of the RFID tag device in a number of suitable manners, such as in a read only memory (ROM) format or in a random access memory (RAM) format, among others. The information stored on each tag can either be broadcast by the tag to a suitable receiving device in the manner of an active RFID tag, or can be broadcast only when the tag is queried by a suitable receiving device, such as by a passive RFID tag.

In normal use, the tags, whether active or passive, are applied to an item that is to be identified by the information stored on the tag. When a suitable receiving device either receives the broadcast of the stored information from an active RFID tag, or queries a passive RFID tag for the information stored on the tag, the tag transmits the information stored in the storage component on the tag to the receiving device. The receiving device can then utilize the information from the tag to identify the tag and the item associated with the tag in order to provide or forward that information to a central controller which keeps track of information regarding a number of RFID tags within a given location. This information can then be utilized to monitor and control inventory of various items associated with the tags, to determine the length of time a particular item has been in a particular location, especially in circumstances where the item associated with the tag has a predetermined shelf life, or simply to determine a particular location of an item associated with a given RFID tag within an area.

However, while RFID tags of this type are highly useful in tracking and/or locating the tags and various items associated with the tags in a specified area, heretofore the use of a tag of this type has typically been confined to uses within individual companies or industries. This is because the tags utilized in these situations are designed with various constraints as a result of their particular application and use that are presented by the particular systems or environments within which they are utilized. For example, tags utilized to identify and locate items within a warehouse for one industry are required to be compatible with the particular computing systems and associated security protocols utilized by that industry. As such, the computing systems and security protocols for that company or industry are often not compatible with computing systems from other companies in the same industry, such that there is no ability to transfer information between differing companies due to the significant differences between the computing systems utilized by different companies.

In addition, even when certain companies within a given industry utilize similar computing systems and security protocols allowing for a certain level of sharing of information stored on various RFID tags utilized within the industry, often times the identifying characteristics of the RFID tags can be duplicated on two or more tags such that the computing system registers a single item as being located at a number of locations at the same time. This, in turn, causes significant confusion and delay with regard to identifying particular items associated with each of the duplicate RFID tags.

As a result, it is desirable to develop a system and method of utilizing RFID tags that employs the tags and information contained thereon in a globally standardized manner such that the tags can be utilized to identify various items in multiple locations utilizing the same computing system and method. Further, it is desirable that the computing system be easily employable by any number of companies such that the system does not require significant additional time and expense to be incurred on the part of the company utilizing the system and method due to the inherent characteristics of the system and method with regard to the use of the RFID tags.

### SUMMARY OF THE INVENTION

According to a first aspect of the present invention, the system and method enables the encapsulating of read only memory or random access memory forming static RFID tag device or label information into a standardized format, such as an IANA/IEEE Internet Protocol Version 6 (IPv6), or other globally routable standard for routing the data in a standardized manner through the Internet and/or various Internets. By formatting the information stored on the RFID tag into a globally routable standard, this information and the location of the tag can be determined and/or traced utilizing various Internet protocols and the routing and neighbor tables associated with those devices. The RFID tags and items associated therewith can be traced to or within specific areas or intranets utilizing any one of a number of Internet control message protocol messages such as Traceroute, Ping, Router Solicitations/Advertisements, Neighbor Solicitation/Advertisements, and the like. Additionally, a static RFID tag or label can also identify itself either in a passive or active manner to a particular receiving device or database through identification of the RFID tag as a standard globally routable protocol address node in a wireless or wired network through the Internet.

According to another aspect of the present invention, the use of RFID tags including information standardized to a globally routable format and/or protocol reduces the number of external databases and database configurations necessary for tracking items. This is because the system and method allows the tracking of the RFID tags including the globally routable standardized information using associated routing and neighbor tables created for use in these standardized Internet routing format and found within various multilayer switching devices and routers that can now be used as temporary or permanent databases from which the RFID static tag or label information can be extracted or parsed.

According to still another aspect of the present invention, the standardization of the information contained on the static RFID tags to a single globally routable communications protocol allows for the complete multi-vendor operation of the system beyond the specific intranet or corporate enterprise. This in turn allows for the standardized globally routable information stored on the RFID tags to be routed throughout the Internet.

According to still a further aspect of the present invention, when storing information on the RFID tags utilizing the standardized globally routable format, a Quality of Service and Flow Label control techniques can be utilized to control, i.e., speed up or slow down, the flow of the standardized information from the RFID tags being routed or exchanged between the tags and various receiving devices, which was not possible utilizing previous data encapsulation formats.

According to still another aspect of the present invention, the standardization of the information on the RFID tags to the globally routable format enables the embedded security formats within the globally routable format to ensure that adequate security measures are implemented and enforced throughout an intranet, enterprise or global Internet, without requiring separate security protocols to exist at or within any particular enterprise or other location.

According to still a further aspect of the present invention, the use of RFID tags including standardized information along the globally routable format eliminates the potential for duplication of information on a particular RFID tag as the globally routable format protocol allows for detection of duplicate addresses and subsequent modification thereof within the global Internet.

Finally, according to still another aspect of the present invention, standardization to the IPv6 protocol allows for router or multi-layer switch global positioning satellite location to be made available for use with various transportation routing programs and/or algorithms. This ability can greatly reduce supply chain costs, such as fuel and storage costs associated with an item, due to the ability to accurately locate and track an item through the Internet.

Numerous other features, objects and advantages of the present invention will be made apparent from the following detailed description taken together with the drawing figures.

### BRIEF DESCRIPTION OF THE DRAWINGS

The drawings illustrate the best mode currently contemplated as practicing the present invention.

In the drawings:

FIG. 1 is a schematic view of the method and system of the present invention that is used to identify and locate an item including an RFID tag with information stored thereon in a standardized globally routable format;

FIG. 2 is a flow chart illustrating the process of retrieving information on an item and configuring the information stored on an RFID tag into a globally routable format utilizing the system of FIG. 1;

FIG. 3 is a flow chart illustrating the process of locating and tracing the location of an item identified utilizing the system of FIG. 1;

FIG. 4 is a flow chart illustrating the process of locating a RFID tag and item associated therewith to manage inventory utilizing the system of FIG. 1;

FIG. 5 is a schematic illustration of the step of sending an ICMP message to a routing device by the system of FIG. 1;

FIG. 6 is a schematic view of the step of updating a routing device neighbor table in response to the ICMP message by the system of FIG. 1;

FIG. 7 is a schematic view of the step configuration of a unique standardized globally routable format for the address received from the tag by the system of FIG. 1;

FIG. 8 is a schematic view of the step of reaching the item utilizing the ICMP message command for the standardized format address by the system of FIG. 1;

FIG. 9 is a schematic view of the step of updating a neighbor table in response to the standardized formatting of the address by the system of FIG. 1;

FIG. 10 is a schematic view of the step of requesting a trace program to run to determine the location of the particular tag and item associated therewith by the system of FIG. 1;

FIG. 11 is a schematic view of the step of receiving an error in response to the trace program request by the system of FIG. 1;

FIG. 12 is a schematic view of a completed trace request run to determine the location of the selected standardized format address by the system of FIG. 1;

FIG. 13 is a schematic view illustrating the step of updating a remote host/user associated with the location of the standardized format address and item associated therewith by the system of FIG. 1; and

FIG. 14 is a schematic view of the step of performing a global positioning system location function by the system of FIG. 1.

### DETAILED DESCRIPTION OF THE INVENTION

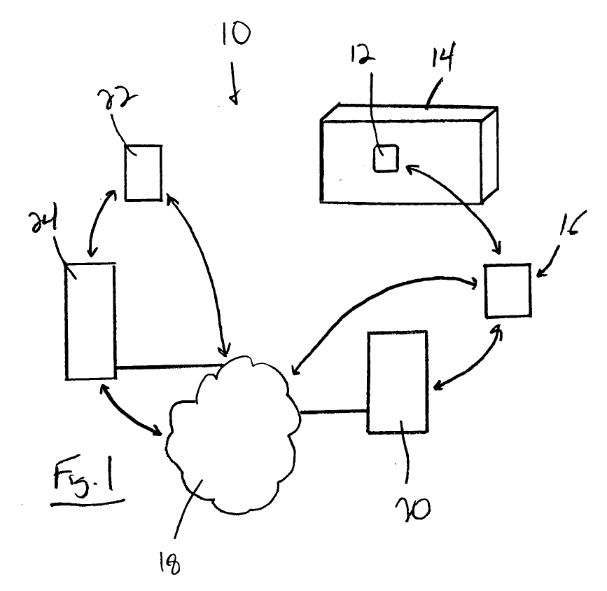

With reference now to the drawing figures in which like reference numerals designate like parts throughout the disclosure, a system constructed according to the present invention is illustrated generally at 10 in FIG. 1. The system 10 generally includes an RFID tag 12 that is affixed to an object 14 in order to identify and provide additional information regarding the object 14. The tag 12 can be an active or passive radio frequency identification data (RFID) tag or label capable of communicating with one or more mobile routing devices 16. The tags 12 operate within one or more unlicensed frequency bands, for example, the ISM band. The tags 12 can be any suitable RFID tags, but preferred tags 12 are those incorporating three- dimensional antennas (not shown) disclosed in co-pending and co-owned U.S. Provisional Patent Application Ser. No. 60/736,566 (the '566 Application), which is incorporated by reference herein in its entirety. Due to the narrow band with the number of frequency channels associated with some unlicensed bands, these tags 12 can be segmented into specific frequencies within the available bandwidth and utilize the adaptive frequency hopping characteristics associated with many communications protocols, for example, Bluetooth, WiMAX, UWB (Ultra Wide Bandwidth), 60 GHz millimeter wave frequencies or Zigbee. Additionally, the tags 12 can operate within licensed bands. The tag 12 may be suitably affixed or otherwise associated with an item, device, human or animal to be monitored. For instance, tag 12 can be embedded within a cap or label of an object or item 14, such as a bottle for medicine or liquids for the commercial consumer market, or held on an adhesive label (not shown) that is applied to the exterior of the item 14.

The mobile data or routing device 16 that communicates with the tag 12 is employed to enable the dynamic transport of information originating from the tags 12 associated with the object 14 or potentially collecting information from a barcode or a webcam scanning device. The mobile routing device 16 may be implemented in any suitable manner, such as a pocket PC type device, and can travel via train, truck, tractor trailer, forklift, human carrier, automated forklift, and in other manners, and communicates with the tags 12 via any suitable wireless communication method, such as Bluetooth, Wi-Fi, WiMAX, UWB, 60 GHz, millimeter wave frequencies or Zigbee. In certain implementations of the system, the mobile data or routing device 16 can be implemented as a stationary device. The mobile routing device 16 also acts to store data in certain situations to act as a local central processing unit (CPU) server 20, for example having DHCP/BOOTP address assignment capabilities. Further, in certain embodiments, a relay agent may act as the mobile routing device, or a mobile node address configurator.

In addition to receiving and storing the data transmitted by the tag 12, the mobile routing device 16 may also act as a power source to activate a powered-down active tag 12, or to directly supply power to a passive tag 12 when the tag 12 has the form disclosed in the co-pending and co-owned '566 Application, discussed previously. This can be accomplished by activating a battery powered active tag 12, or by supplying a power source for a passive tag 12. To do so, the mobile routing device 16 supplies a power signal at a frequency range that is higher than the optimized antenna frequency for reception and transmission of information from the tag 12. The ability to supply a power source to the tags 12 from the mobile routing device 16 exploits the maximum output power allowed within higher unlicensed bands and the directivity associated with these higher frequencies in these bands.

The mobile routing device 16 can either be connectable to a global computer network or Internet 18 via network routing device, multi-layer switch 20, or to a local central processing unit server 20 depending upon the location and situation within which the tag 12 is disposed. Also, the tag 12 can transmit information directly to the server 20 without use of the mobile routing device 16. The information transferred from the tag 12 to the global computer network 18 via one or both of the mobile routing device 16 network routing device, multi-layer switch, or server 20 can be accessed by a separate CPU or server 22 and/or mobile routing device 24 in order to allow the information contained on the tag 12 to be transmitted via the global computer network 18 as necessary or desired.

To facilitate the transmission of this information through the global computer network 18, the information stored on the tag 12 is configured into a standardized globally routable format that enables the data to be transmitted from the tag 12 through a suitable device 16 or 20 and through the Internet 18 to another suitable device 22 or 24. While a number of standardized globally routable formats can be utilized for the data stored on the tag 12, a preferred format is the Internet Protocol Version 6 format (IPv6). By storing the data on the tag 12 in the standardized IPv6 format, in addition to the ability to route the information from the tag 12 through the Internet 18, a number of additional benefits are obtained.

In one embodiment, the tag 12, such as those disclosed in the '566 Application, includes an antenna (not shown) including an integrated circuit chip, and may be implemented as a system-on-chip utilizing various semiconductor technologies that are known in the art. The tag 12 contains sufficient binary-coded data to identify the tag 12 as a slave device to the globally routable communications protocol utilized by a particular mobile routing device 16. For example, the data can be stored on the tag 12 in chip read only memory (ROM) or in a read-write random access memory (RAM) as a bit pattern, such as like a media access control (MAC) address. Utilizing a predetermined binary-coded bit(s) standardized globally routable format, such as the IPv6 format, a minimal amount of data is transferred per tag 12 across the tag to mobile data device antenna air gap in response to a query to the tag 12 from the device 16. Alternatively, when a barcode is present on the object 14 instead of a tag 12, the barcode can be scanned and the object 14 can identify itself as a slave device to the communications protocol of the mobile routing device 16. Additionally, the data transfer between the tags 12 and the mobile device 16 can incorporate or conform to known standards.

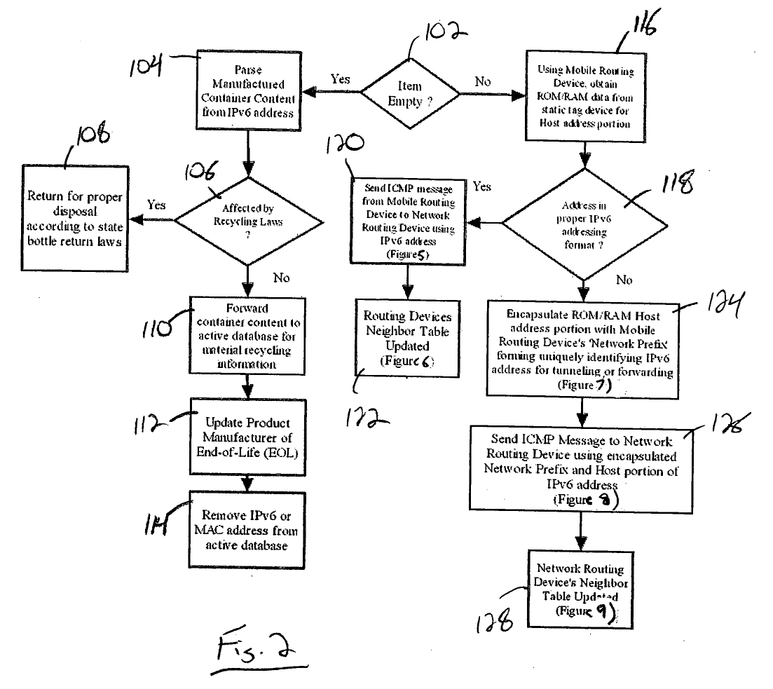

Referring now to FIG. 2, the process for the utilization of the system 10 including the RFID tags 12 having identification data stored therein in a standardized Internet-compatible format as illustrated. Initially, in block 102, a suitable mobile routing device 16 or server 20 is activated in order to query the tag 12 on the object 14. In this particular embodiment of the use of the system 10, the tags 12 are queried whether the object or container 14 to which the tag 12 is attached is empty, for example, if all of the items previously located within the container 14 have been removed and/or utilized. However, other potential queries for the tag 12 can include whether the container 14 has exceeded its expiration date based on imbedded information in the tag 12 regarding the creation date of the container 14, among other potential queries. If the object 14 is empty, the information retrieved from the tag 12 by the device 16 is utilized to determine the particular material utilized to form the container 14. Based on this information, the device 16 can determine in block 106 whether the container 14 is covered or affected by any recycling laws in the municipality in which the container 14 is located. If so, in block 108 the device 16 indicates that the container 14 is returned for proper disposal in accordance with the recycling laws. However, if the container 14 is not affected by any particular municipal or local law, in block 110, the device 16 forwards the container content information obtained from the tag 12 to an active database to determine the recycling information for the material forming the container 14. Additionally, this information obtained from the tag 12 is forwarded in block 112 to the manufacturer of the container 14 to inform the manufacturer of the end of life of the particular container 14. As a result of this indication to the manufacturer, in block 114, the particular or unique standardized globally routable format address stored on the tag 12 is removed from the active database at the manufacturer as the tag 12 is essentially decommissioned, such that the address can be utilized on a subsequent tag 12 utilized on a similar container 14. The information concerning the content of the container 14 routed to the manufacturer can also be used to determine the supply and demand for that material, as well as the associated pricing required for the material.

Alternatively, if in block 102 it is determined that the object 14 is, e.g., not empty, or has not yet exceeded its useful life, the device 16 queries the tag 12 in order to determine the identification address and other data from the tag 12 in block 116 in order to record the particular location of the object 14 based on the known location of the device 16. In block 118, the device 16 then determines whether the tag address is in the proper standardized globally routable format, preferably the IPv6 addressing format. If the address is in the proper standardized globally routable format, in block 120, the mobile routing device 16 sends an Internet Control Messaging Protocol message (ICMP) to the associated network device 20 that includes the standardized format data from the tag 12. Subsequently, in block 122, the neighbor table in the network routing device 20 is updated with the information from the tag 12, including the standardized globally routable format address for the tag 12, to illustrate the particular location for the object 14.

Alternatively, if the binary-coded data from the tag 12 as received by the mobile routing device 16 is not in the proper standardized globally routable format, in block 124 the system 10 creates a proper standardized globally routable format address for the tag 12. To do so in the example of the IPv6, 128-bit structure, a variable bit host portion, e.g., data from the tag 12, is linked with a networked prefixed portion from the mobile routing device 16 to form the globally unique identifying and IPv6 standard formatted unicast address for the tag 12. Subsequently, the device 16 sends the Internet Control Messaging Protocol message including the revised address for the tag in block 126 to the network routing device 20 which then updates the neighbor table in block 128 with the revised address for the tag 12 to illustrate the present location of the object 14, similarly to block 122. This process can also be accomplished when the information on the tag 12 is implemented utilizing nanotechnology.

The data transfer between the tags 12 and the mobile routing devices 16, when conforming to the standardized globally routable format, the necessity of configuring multiple CPU servers and databases located within a network is greatly reduced. This is because the routing table and/or neighbor table in a router or multi-layer switch, whether the device 16 or the server 20, becomes a standardized replacement for these databases and the routing protocols in these devices become the format for moving the data from site-to-site. In a particular embodiment, a dual-stack router (not shown) is configured, and tunnel mechanisms are used to encapsulate the data into a 6 to 4 (six-to-four) tunneling for transfer to autonomous IPv6 networks located within an enterprise, and intranet or a global network. Further, using this format, the quality of service and flow control techniques associated therewith can also be used to control the flow of the data being routed.

Looking now at FIG. 3, the system 10 enables the network routing device 20 to be queried via a suitable local mobile device 16, or a remote network device 22 or a remote routing device 24 via the Internet 18 to determine the present location and to trace the route of a particular tag 12 and the associated object 14 in block 130. If this trace function is not desired, the system 10 proceeds to block 132 until any further queries are sent to the respective tags 12 to update the neighbor tables on the network routing device 20, or when a subsequent trace request is sent to the network device 20.

However, if a request to locate a particular tag 12 and/or locate trace the route of the particular tag 12 to that location is submitted to the system 10, the system 10 proceeds from block 130 to block 134 and uses a standard trace route or tracert commands to locate the particular tag 12 corresponding to the data submitted as a part of the trace route request. In doing so, the request for the particular address associated with a tag 12 of interest is submitted to the network devices 20 in selected areas of the system 10 in order to determine whether information concerning the particular standard globally routable format address for that tag 12 is present on the neighbor tables contained therein. These areas can include, for example, a manufacturing area, a distribution network, a warehouse pallet, a retail area location, or any other location where a mobile routing device 16 is present. The trace request can also be submitted to globally search for and trace the route of a particular tag 12 and object 14 if desired.

In block 136, if the neighbor table of a selected network device 20 does not contain information concerning the address for the unique tag 12 sought to be located or traced, the system 10 proceeds to block 138 and notifies the device 16, 22 or 24 from which the trace request was sent of the absence of the address from the neighbor tables in the network device 20. Additionally, the trace request for the particular tag is queued for a future request to the neighbor table to the same network device 20. Once the request has been queued, the system 10 proceeds to block 140 to determine whether the neighbor tables of the particular network device 20 have been updated. If not, the system 10 recycles back to block 138 and continually determines the update status of the neighbor tables of the network device 20. Once the neighbor tables of the device 20 have been updated with the information in the standardized globally routable format concerning the particular tag 12, such as by scanning the tag 12 with a mobile routing device 16, the system 10 proceeds to block 142 to notify the remote device 16, 22 or 24 of the update. Alternatively, the tag 12, if configured as an active tag, can also identify itself as a node on the network to an associated network device 20 with its standardized globally routable format address.

The system 10 in block 144 then creates a location report for the tag 12 in response to the trace request and forwards the report to the requesting device 16, 22 or 24. This report contains information on the present location and path to that location for the tag 12 and associated container 14 having the unique address sought in the trace request as determined from the neighbor table updates in various network devices 20.

Similarly, when the system 10 in block 136 does not receive an ICMP error message from a selected network device 20, indicating that the updated neighbor table for the particular network device 20 contains the unique address associated with the specified tag 12, the system 10 proceeds to block 146 and utilizes the standardized globally routable format address information to identify the particular location for the tag 12 and associated container 14 and/or the route taken by the tag 12 and object 14 to that location. The system 10 then moves from block 146 to block 144 to provide the location report for the tag 12 in response to the trace request, as discussed previously. As opposed to, or in conjunction with the location determined by the neighbor tables in block 146, the location of the tag 12 and object 14 can also be determined utilizing known global positioning system (GPS) data that are incorporated into the unique standardized globally routable address, which are then incorporated into the location report.

After the creation and forwarding of the location reports, the system 10 proceeds to block 148 and can run an optional optimization routine to determine whether the traced physical transportation route for the particular tag 12 and associated container 14 was most efficient in terms of the route taken for the container 14 from its origination point to the end point.

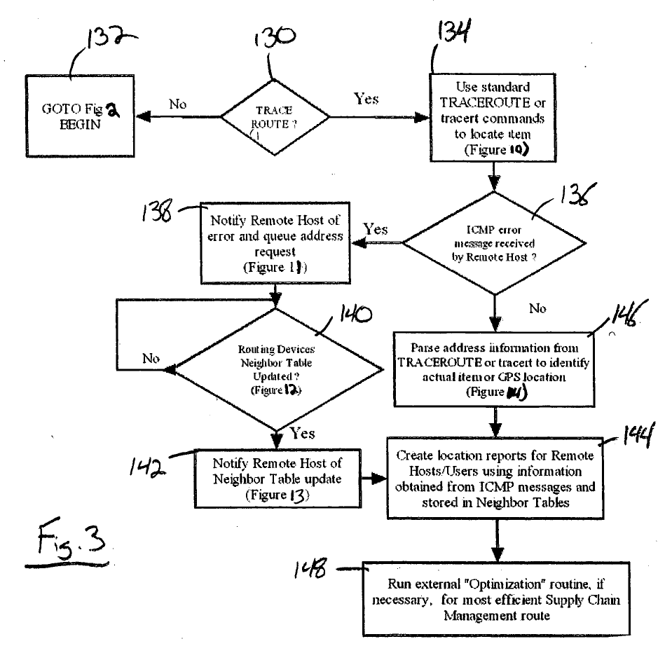

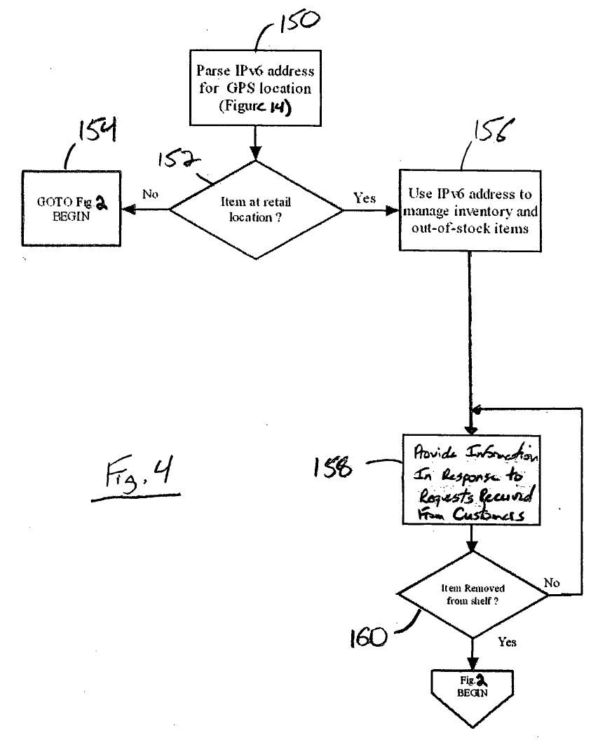

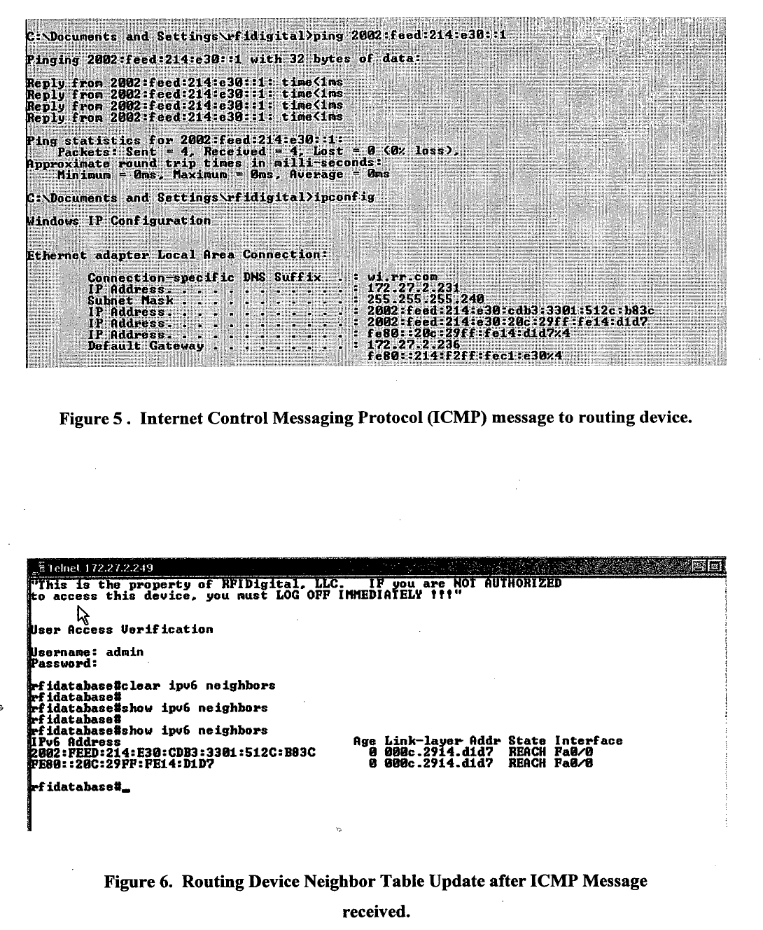

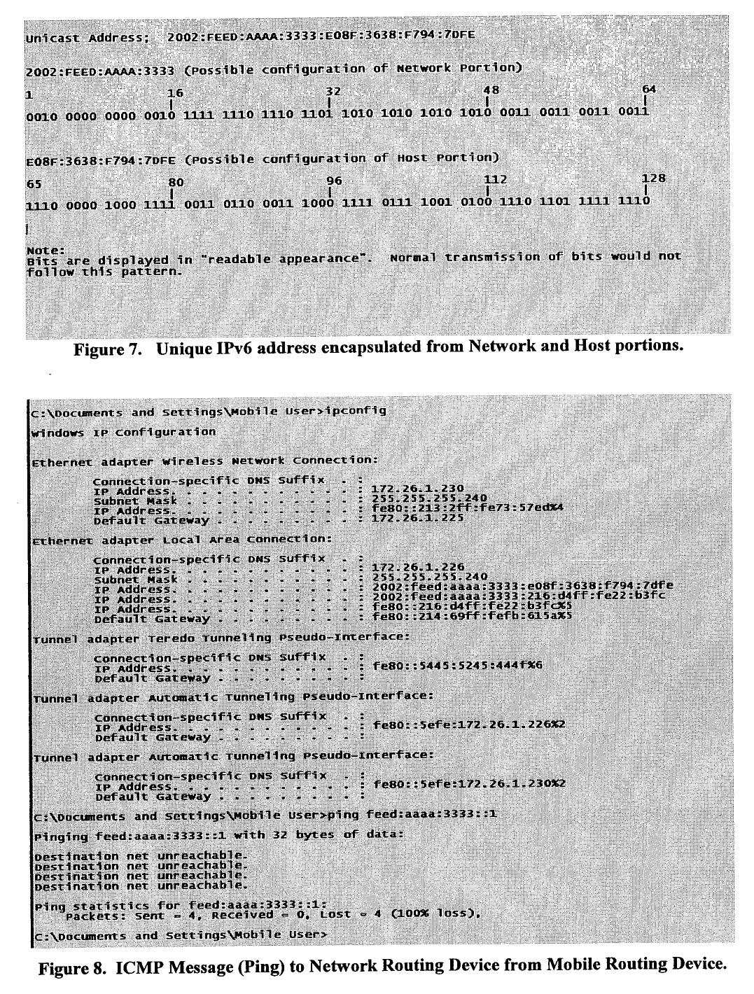

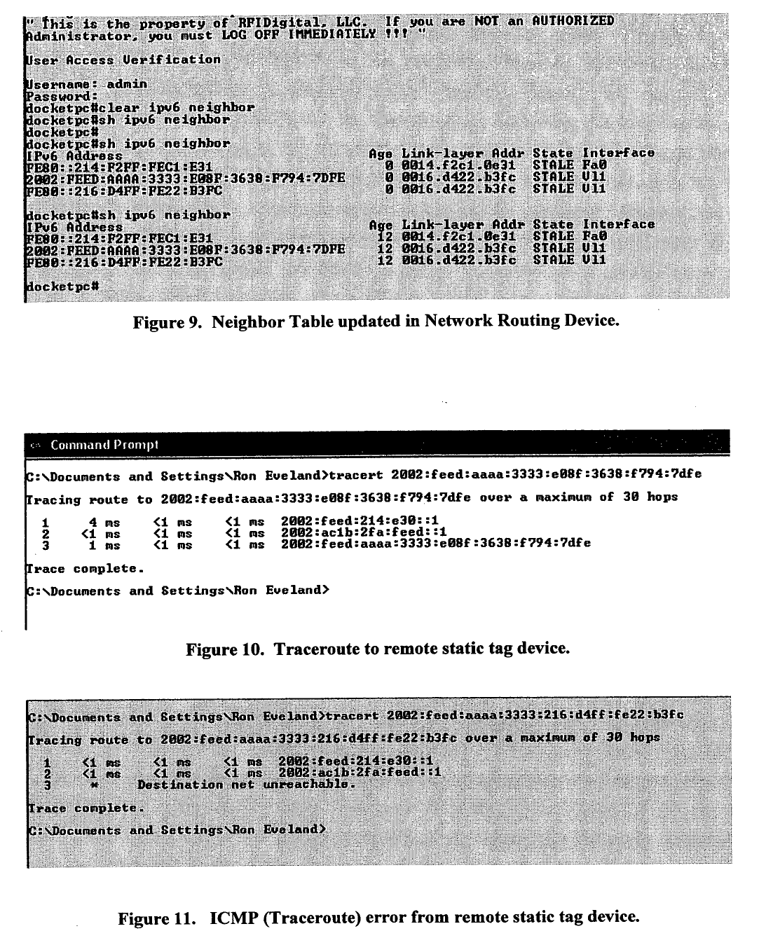

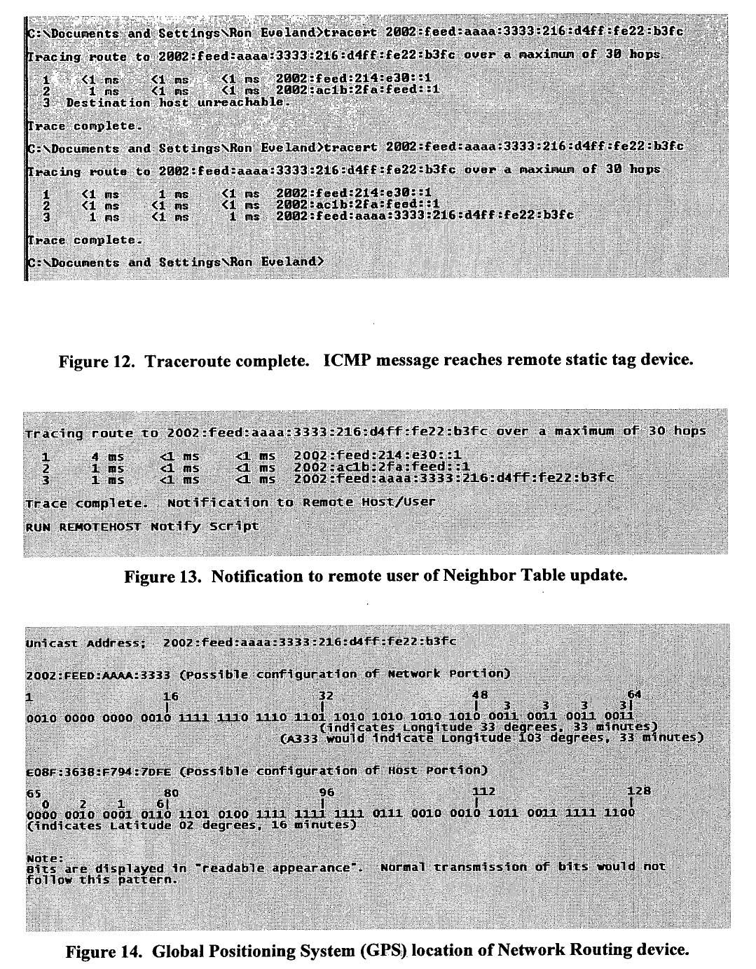

Referring now to FIG. 4, in an adaptation of the system 10 for utilization of the system 10 in an inventory and out-of-stock management capacity, once a tag 12 and particular item 14 to be sold at a particular retail location have been located and identified at a particular location in block 150, pursuant to requests or updates from remote or local devices 16, 22 and 24 in the manners discussed previously regarding FIGS. 2 and 3, the system 10 can determine in block 152 whether the item 14 is disposed at the retail location, or, for example, still within the distribution chain leading to the retail location. If no, the object 14 is not yet present at the retail location, the system 10 proceeds to block 154 and awaits a subsequent update of a network device 20 at the retail location, or a trace function request to be submitted to the system 10 in order to re-determine whether the tag 12 and object 14 are present at the retail location.

However, if in block 152 the system 10 determines that the object 14 is at the retail location, the system 10 proceeds to block 154 to utilize the standardized globally routable format address for the object 14 to determine the number of objects 14 at the particular location. With this particular inventory information provided by the tags 12 disposed on each of the items 14 present at the retail location, in block 158 the system 10 can provide various types of information regarding the objects 14 located at the retail location in response to both in person and online requests for information. For example, the retail location can use the information provided by the system 10 to field price comparison requests from an in- store or on-line customer, to provide these requests to manufacturers to solicit responses to the customer requests, such as for special order items, and to provide dynamic on-line couponing to/from the manufacturers to the customers.

In addition, the system 10 in block 160 can determine whether the object 14 has been moved from the location based upon an update in the neighbor table of the local network device 20 of the tags 12 and associated objects 14 present at the retail location using the process of FIG. 2. If the object 14 was purchased, the system 10 can determine whether the object 14 has been removed from the location for shipment or other delivery to the customer. If the object 14 has been purchased and removed, the system 10 can update the inventory at the retail location suing the process of FIG. 2. However, if the object 14 has not yet been removed, or if no object 14 was purchased, the system 10 moves back to block 156 to utilize the unique and standardized globally routable format addresses on the tags 12 affixed to the objects 14 to manage the inventory at the retail location. This also provides the retail location with the ability to enable a supplier of the objects 14 to access the globally routable information contained on the tags 12 to determine when more objects 14 will be needed at that location, as well as when those objects 14 have arrived at the retail location.

In other embodiments, the tags 12 used in the system 10 can communicate with a mobile routing device 16 in a structured format that enables the devices 16 to utilize existing standard features, such as wireless headsets or glasses, as well as safety goggles with embedded wireless microphones. The wireless approach allows for radio communications or Voice over Internet Protocol (VoIP) communications within a central network, technical support call center, and the like for transporting products throughout a specified distribution network. As such, the device 16 can function as both an interrogating device for tracking the tags 12 and the associated objects 14, and as a GPS location/voice communication device for the individuals transporting the objects 14.

In other embodiments, the tags 12 including the information stored in the standardized globally routable format can be used by the system 10 to locate and/or trace objects 14 in a consumer's home. This enables the system 10 a provide dynamic additions and subtractions to a shopping list, to provide information to the consumer regarding expiration dates of products, and to enable price comparison shopping and automatic couponing when the consumer shops in a store or online with a suitably configured mobile routing device 16.

Also, in the employment of the system 10 in the warehousing and transportation industries, the mobile routing device 16 can replace the carbonless dockets currently utilized to keep track of the movement of goods onto and off of cargo carriers and docks, and into and out of storage areas. Additionally, the system 10 allows for the tracking of the goods from the point of origin throughout the distribution network to the ultimate destination over the Internet, or through an enterprise intranet, or both.

Various alternatives are contemplated as being within the scope of the following claims particularly pointing out and distinctly claiming the subject matter regarded as the invention.

What is claimed is:

1. A system for locating or tracing the location of objects, the system comprising:
a) a radio frequency identification data tag adapted to be secured to an object and including a data storage device and an antenna operably connected to the data storage device, the data storage device including information regarding the object to which the tag is adapted to be secured stored therein in a standardized global computer network- compatible format; and
b) a first device capable of receiving the information in the standardized global computer network-compatible format in transmitting the information to a global computer network.

2. The system of claim 1 wherein the device is a mobile routing device.

3. The system of claim 1 wherein the standardized, global computer network-compatible format is Internet Protocol Version 6.

4. The system of claim 1 further comprising a second device that is remote from the first device and configured to receive the information in the standardized, global computer network-compatible format transmitted from the first device via the global computer network.

5. The system of claim 1 wherein the mobile routing device is a hand-held computing device.

6. The system of claim 5 wherein the mobile routing device is configured to be utilized as a voice communication device.

7. A method for locating an item a computer network, the method comprising the steps of:
a) providing a radio frequency identification data tag;
b) configuring the tag with a unique identification code and a standardized, global computer network-compatible format;
c) applying the tag to the item; an
d) transmitting the identification code from the tag to a first device capable of receiving the identification code from the tag.

8. The method of claim 7 wherein the first device is operably connected to the computer network and further comprising the step of transmitting the identification code from the tag over the computer network to a second device operably connected to the computer network.

9. The method of claim 8 wherein the step of transmitting the identification code comprises the steps of:
a) activating a tag in response to an electronic query from the first device;
b) accessing the identification code stored in the tag; and
c) sending the identification code to the first device.

10. The method of claim 8 further comprising the step of updating a database of located identification codes within the first device after transmitting the identification code to the first device.

11. The method of claim 10 further comprising the step of determining the location of the tag by searching the database of located identification codes after updating the database.

12. The method of claim 10 wherein the identification code includes information concerning previous locations of the tag and wherein the method further comprises a step of tracing a path of the tag between separate locations by searching the database of located identification codes in response to a trace request.

13. The method of claim 12 further comprising the step of performing an optimization analysis of the traced route of the identification code in comparison with an optimal route after tracing the path of the tag.

14. The method of claim 12 further comprising the steps of:
a) sending an error message to a source of the trace request if the identification code is not located; and
b) queuing the trace request to be redone after a subsequent update of the database of identification codes.

15. The method of claim 7 wherein the computer network is a global computer network.

16. The method of claim 7 wherein the computer network is a company intranet.
